(19) United States
(12) Patent Application Publication
(10) Pub. No.: US 2006/0057917 A1
(43) Pub. Date: Mar. 16, 2006

(54) Ready-heat™ disposable heated blanket

(76) Inventors: Arthur Horowitz, Potomac, MD (US); Robert Gordon, Potomac, MD (US)

Correspondence Address: ROBERT GORDON, 7917 TURNCREST DRIVE, POTOMAC, MD, 20854, US

(21) Appl. No.: 10/866,787

(22) Filed: Sep. 15, 2004

(51) Int. Cl. B32B 5/02

(52) U.S. Cl. 442/79; 442/131

(57) ABSTRACT

The general abstract of the READY-HEAT™ disposable heated blanket is that of a blanket that will be produced in a variety of sizes that will be manufactured using synthetic non-woven fibers. Each blanket will than contain numerous pockets containing non-electrical chemical heating packets. The entire blanket with these sealed in heating elements (Chemical) will then be wrapped in a protective film. When the film is opened for use, the contents of the sealed in heating elements will react with the oxygen in the atmosphere and generate heat. The heat that will be generated will provide sufficient warmth and comfort to the user for several hours. Many of the blankets will be produced using a water repellent finish. Some blankets will also provide for UV protection. The blanket when sealed will also in certain circumstances, be inserted with an oxygen indicator that will change colors in the event that any oxygen has inadvertently entered the sealed packaged in an effort to identify any potentially defective blankets.

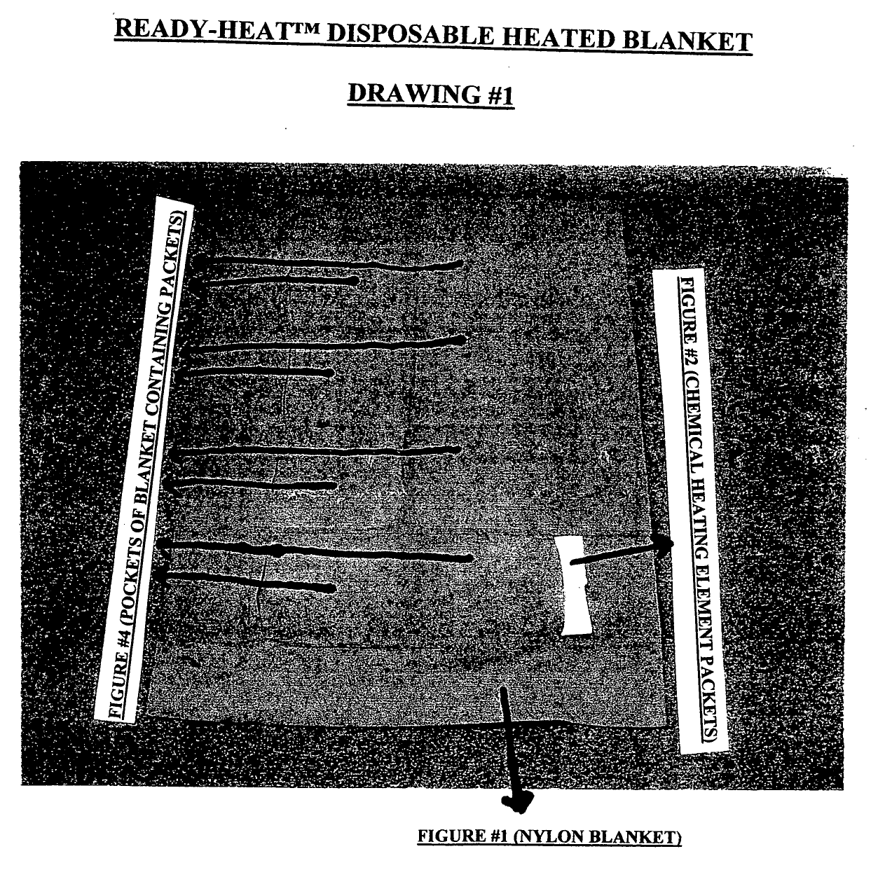

### A. OVERVIEW

The Ready-Heat™ blanket is comprised of three major components, the nylon blanket (FIG. #1 of attached drawing #1), the heating (chemical) element (As seen in drawing #1 labled FIG. #2) and the outer polybag (FIG. #4 as shown in drawing #2). The medical disposable heated blanket remains warm (40° C.) for approximately 6-8 hours when the blanket is exposed to ambient temperature. This activation occurs when the polybag is opened. The referenced components are illustrated in the two attached line drawings of the invention.

### B. NYLON BLANKET

The synthetic nylon blanket (without the chemical heating element) is a medical disposable bedding, comprised of Eltasmaster®, Eltas® nylon spundbond material (Component 1). In accordance to the material safety data sheet, the ingredients consist of 98% polycapronamide and 2% titanium dioxide. The blanket contains numerous pockets (FIG. #3 of drawing #1) where the heating element packets are securing placed.

### C. HEATING ELEMENT

In a 2×4 inch packet comprised of a face side-nylon non-woven fabric inside-polyethylene laminate film pierced needle holes, the chemical ingredients include: iron powder (50-60%), water (15-25%), activated charcoal (5-10%), water vermiculite (1-3%), salt (2-5%), wood powder (2-5%) and water absorptive powder (0.1-1%), Component 2.

### D. POLYBAG

The outer polybag consists of a “KOP” polypropylene film of vinyliden chloride coated material.

1. I CLAIM that the general description of the READY-HEAT™ disposable heated blanket Is that of a blanket that will be produced in a variety of sizes that will be manufactured using synthetic non-woven fibers. Each blanket will than contain numerous pockets containing non-electrical chemical heating packets. The entire blanket with these sealed in heating elements (Chemical) will then be wrapped in a protective film. When the film is opened for use, the contents of the sealed in heating elements will react with the oxygen in the atmosphere and generate heat. The heat that will be generated will provide sufficient warmth and comfort to the user for several hours.
Many of the blankets will be produced using a water repellent finish. Some blankets will also provide for UV protection.
The blanket when sealed will also in certain circumstances, be inserted with an oxygen indicator that will change colors in the event that any oxygen has inadvertently entered the sealed package in an effort to identify any potentially defective blankets.
